(19) United States
(12) Patent Application Publication
(10) Pub. No.: US 2006/0119010 A1
(43) Pub. Date: Jun. 8, 2006

(54) Moldable substance

(76) Inventor: Heinrich Schnorrer, Schwandorf (DE)

Correspondence Address: Friedrich Kueffner, Suite 910, 317 Madison Avenue, New York, NY, 10017, US

(21) Appl. No.: 11/271,514

(22) Filed: Nov. 12, 2005

(30) Foreign Application Priority Data
Aug. 13, 2004 (DE) 10 2004 039 270.6

(51) Int. Cl. B29C 35/08

(52) U.S. Cl. 264/402

(57) ABSTRACT

A moldable substance capable of being dried and hardened by supplying energy from energy sources, wherein the energy source is a microwave device, and wherein the substance is composed of the components binder, filler, and water and possibly coloring agents and/or other additives. The binder contains at least one inorganic component and the inorganic component has a high porosity.

### BACKGROUND OF THE INVENTION

1. Field of the Invention

The present invention relates to a moldable substance which is dried and hardened by supplying energy from energy sources.

The present invention also relates to a method of using the substance.

In accordance with the present invention, the moldable substance is an air-drying substance which can be placed in heating furnaces for accelerating the solidification or hardening of the substance, or can be hardened by means of irradiation as the energy sources.

2. Description of the Related Art

Moldable or plastic substances which are air-drying and oven-hardening are known in principle.

These substances have the disadvantage that even if the models are small, drying and hardening at room temperature up to complete drying or hardening requires at least 24 hours. If the pieces are larger, drying may even take several days. In connection with such substances, it has been found that even when accelerated drying in a baking oven is carried out, the required hardening period is still several hours.

Attempts to dry and harden such water-based moldable substances in a microwave for drying and hardening have produced the result that the substance initially dries at its surface, which produces the result that no water vapor can diffuse from the interior of the model to the outside. The pressure of the water steam in the interior of the model causes cracks and blisters at the surface of the model, so that the models become unattractive and unstable. In extreme cases, the internal pressure can explode the model.

Another disadvantage is the fact that models produced with such substances shrink linearly by at least 4%-10% when air dried or dried in a baking oven. It has also been found that thinner models with layer thicknesses of up to 5 mm have the strong tendency to be distorted during drying.

### SUMMARY OF THE INVENTION

It is the primary object of the present invention to provide a water-based moldable substance which does not have the disadvantages discusses above, wherein models prepared with the substance can be completely dried and hardened in a few minutes without the formation of cracks or blisters.

Another object of the invention is to provide a moldable substance which is not subject to shrinkage, so that a very high dimensional accuracy and adherence to dimension are ensured.

In accordance with the present invention, the energy source for hardening the substance is a microwave device.

Accordingly, the object of the invention is met by placing the models of objects manufactured by means of a moldable substance in a commercially available microwave device and the irradiation produced in the microwave device dries and hardens the models or objects within minutes.

The property of the substance according to the present invention of being hardenable by means of microwave irradiation is due to the fact that the substance contains at least one component which has a high porosity. Once component with a high porosity could be the binder used which contains at least one inorganic component. Examples of inorganic binders are calcium hydroxide, pearlite, and/or bentonite. These binders have a high porosity which ensures at all times of the hardening process a high water vapor permeability because the steam pressure occurring during the hardening process can escape toward the outside through the pores. Due to the use of such binders which ensure at all times a high permeability to water vapor, the surface is not sealed and the formation of cracks and even bursting of a model are safely prevented because the steam pressure in the interior of the models remains low. The same interaction occurs if, instead of porous inorganic binders, fillers are used which have a high porosity.

It has been found advantageous if the moldable substance has as a component at least one organic binder because models manufactured with this substance have in the hardened state a better or higher strength against breakage. In addition, when organic binders are present, a significantly better plasticity or moldability is present in the processing state.

Examples of organic binders are celluloses such as carboxymethylcelluloses, hydroxyethylcelluloses, methylcelluloses, and other cellulose derivatives. Alternatively, it is also possible to use galactomananes or guar meal. It is also possible to use synthetic organic binders, such as polyurethane and/or polyacrylate which are either water soluble, water insoluble or water dispersible. These synthetic binders are preferably used as aqueous dispersions.

It has also been found advantageous that the modeling substance, after hardening in the microwave, has a significantly lower density than in the unhardened state. This has the result that the models become lighter after hardening and even float. The density of the substance in the unhardened state is about 1.05 to 1.5 g/ml and the density of the hardened models is approximately 0.70 to 0.95 g/ml.

The invention will now be described in more detail in connection with several embodiments.

### BASIC EXAMPLE OF A MOLDABLE SUBSTANCE

| | | |
|---|---|---|
| Water | 15-40% | by weight |
| Inorganic binders | 10-50% | by weight |
| Fillers | 8-30% | by weight |
| Organic binders | 0-65% | by weight |
| Coloring agents | 0-7% | by weight |
| Conservation agents | 0-6% | by weight |
| Evaporation retarders | 0-5% | by weight |

### EXAMPLE 1

### Yellow Modeling Substance

| | | |
|---|---|---|
| Water | 28.0% | by weight |
| Calcium Hydroxide | 20.5% | by weight |
| Pearlite | 3.8% | by weight |
| Carboxymethylcelluloses | 19.0% | by weight |
| Aqueous synthetic material dispersion | 15.5% | by weight |
| Chalk | 10.0% | by weight |
| hollow micro glass spheres | 2.8% | by weight |
| CI. Pigment Yellow 1 | 0.2% | by weight |
| 2-bromium-2-nitropropane-1,3-diol | 0.2% | by weight |

### EXAMPLE 2

### Red Modeling Substance

| | | |
|---|---|---|
| Water | 28.8% | by weight |
| Pearlite | 26.5% | by weight |
| Carboxymethylcelluloses | 16.4% | by weight |
| Aqueous synthetic material dispersion of a | 19.5% | by weight |
| copolymerisate of acryl-acid esters | | |
| Kaolin | 3.3% | by weight |
| hollow micro glass spheres | 5.0% | by weight |
| CI. Pigment Red 112 | 0.4% | by weight |
| Conservation agent | 0.1% | by weight |

### EXAMPLE 3

### Blue Modeling Substance

| | | |
|---|---|---|
| Water | 29.0% | by weight |
| Benonite | 37.0% | by weight |
| Carboxymethylcelluloses | 2.0% | by weight |
| Aqueous polyureth-plastic dispersion | 11.0% | by weight |
| amorphous silicic | 14.0% | by weight |
| hollow micro glass spheres | 5.4% | by weight |
| CI. Pigment blue 15 | 1.1% | by weight |
| Conservation agent | 0.3% | by weight |
| Polyglycol | 0.2% | by weight |

### EXAMPLE 4

### Yellow Modeling Mass

| | | |
|---|---|---|
| Water | 35.0% | by weight |
| Calcium hydroxide | 30.0% | by weight |
| Pearlite | 8.0% | by weight |
| Chalk | 23.6% | by weight |
| hollow micro glass spheres | 3.0% | by weight |
| CI. Pigment yellow 1 | 0.2% | by weight |
| 2-bromium-2-nitropropane-1,3-diol | 0.2% | by weight |

Because of the use of a microwave and the porous components of the substance, such as porous binders and/or fillers, extremely short hardening times could be achieved. It has also now been found that, by adding evaporation retarding agents, for example, glycerine, sugar-containing substances, and/or glycols, the binding rate of the substance according to the present invention can be regulated or adjusted.

The particular advantage of hardening by means of microwave radiation is illustrated by the example shown in the following table.

| Initial | Diameter of | Output | Hardening | Final |
|---|---|---|---|---|
| Substance (g) | Spheres (cm) | (watt) | time (min) | weight (g) |
| 20 | 3 | 400 | 6 | 13 |
| 20 | 3 | 800 | 3 | 13 |
| 40 | 4 | 800 | 4 | 26 |
| 80 | 5 | 800 | 5 | 52 |
| 160 | 6 | 800 | 8 | 104 |

The conservation agents which can be used are, just to mention a few examples, a 0.5% solution of 2-bromium-2-nitropropane-1,3-diol or a 0.3% mixture of 5-chlorol-2-methyl-2H-isothriazol-3-on and 2-methyl-2H-isothriazol-3-on can be used. The coloring agents which may be added to the substance may be present in the form of pulverous pigments or aqueous pigment preparations. Representative for a plurality of pigments which can be used, the above samples only show some of the pigments. Titanium dioxide is also frequently used as a coloring agent. There are virtually no limits with respect to the use of color pigments.

The modeling substance according to the present invention can be manufactured by means of conventional devices, particularly with conventional blenders. The components are mixed in the blenders, are kneaded and subsequently extruded. The substance is then packaged in an air-tight manner.

Such a modeling substance is used in the model or prototype construction because samples and models or entire model landscapes must be prepared precisely to scale because no shrinkage occurs during hardening.

Such a modeling substance is additionally used for hobbies and by artists, for example, for manufacturing articles of jewelry, puppets, puppet heads, masks, and many other objects. There are no limits with respect to the use of the substance for producing models for hobbies and artists.

The use of the modeling substance is also recommended in modeling classes for adults, schools, and kindergartens equally because the substances used for the models prepared in classes, schools, or kindergartens hardens within minutes and the creator can take the models home immediately.

Another possible use of the substance according to the present invention is as sealing and insulating and molding substance.

The moldable substance is dried and hardened by supplying energy from energy sources, wherein the energy source for hardening is a microwave device. The substance is composed of the components binder, filler and water, and possibly coloring agents and/or other additives. At least one component has a high porosity which is in a ε-range of 50%<ε<100%.

The binder has at least one inorganic component with a high porosity. Examples for inorganic components are calcium hydroxide, pearlite, and/or bentonite.

While specific embodiments of the invention have been shown and described in detail to illustrate the inventive principles, it will be understood that the invention may be embodied otherwise without departing from such principles.

I claim:

1. A moldable substance capable of being dried and hardened by supplying energy from energy sources, wherein the energy source is a microwave device, and wherein the substance is composed of the components binder, filler, and water and possibly coloring agents and/or other additives, wherein the binder comprises at least one inorganic component and wherein the inorganic component has a high porosity.

2. The substance according to claim 1, wherein at least one component has a high porosity, and wherein the porosity is in a range of 50%<ε<100%.

3. The substance according to claim 1, wherein the inorganic component is selected from the group consisting of calcium hydroxide, pearlite, and bentonite.

4. The substance according to claim 1, wherein the substance is comprised of 15-40% water, 10-50% inorganic binders, 8-30% fillers, 0-65% organic binders, 0-7% coloring agents, 0-6% conservation agents, 0-5% evaporation retarders.

5. Method of hardening a moldable substance composed of binders, fillers, and water, the method comprising hardening the substance by means of microwave energy.
